(19) United States
(12) Patent Application Publication
(10) Pub. No.: US 2016/0135398 A1
(43) Pub. Date: May 19, 2016

(54) VERTICAL GROWING SYSTEM AND METHOD

(71) Applicant: BELLWETHER INNOVATIONS, LLC, Spring, TX (US)

(72) Inventors: Sandra Lee MATHIEU, Spring, TX (US); Neil James GILLBANKS, Houston, TX (US)

(73) Assignee: BELLWETHER INNOVATIONS, LLC, Spring, TX (US)

(21) Appl. No.: 14/943,329

(22) Filed: Nov. 17, 2015

Related U.S. Application Data
(60) Provisional application No. 62/080,896, filed on Nov. 17, 2014.

(51) Int. Cl. A01G 31/06

(52) U.S. Cl. CPC A01G 31/06

(57) ABSTRACT

A vertical growing system is provided which utilizes a plurality of plant receptors positioned on a container. The container has a plurality of holes drilled therein. Each of the plant receptors has a hollow pocket formed with a plate. The plate has an opening on the rear side thereof for positioning over the hole drilled in the container. The plate has flanges extending outwardly from the pocket that can form to the shape of the exterior of the container. A plant portal in the hollow pocket allows the plant to grow outwardly of the plant receptor apparatus. A method of vertical growing is also disclosed.

### RELATED U.S. APPLICATIONS

The present application claims priority to Provisional Patent Application No. 62/080,896, filed on Nov. 17, 2014, and entitled “Molded Pockets for Growing Plants Vertically”, presently pending.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

The present invention relates to the field of horticulture. More particularly, the present invention relates to a system for growing plants vertically. Even more particularly, the present invention relates to pockets for growing plants vertically which have flanges that are attachable to a container.

2. Description of Related Art Including Information Disclosed Under 37 CFR 1.97 and 37 CFR 1.98.

For centuries, people have potted plants in order to be able to enjoy greenery indoors and in other soil less environments, such as patios and concrete-covered outdoor areas.

Round flowerpots are very common containers. However, they generally hold only one plant. Rectangular boxes are a common way to hold multiple plants in one container. Generally, these boxes rest on the ground or are attached to windowsills or railings. Unfortunately, this type of container requires a large amount of horizontal space. Horizontal space is often scarce, particularly for city dwellers and office workers or in classrooms. To reduce the amount of horizontal space used by multiple plants, designers developed tiered shelves that can accommodate several pots. Unfortunately, tiered shelves are cumbersome and make watering multiple plants difficult. Additionally, they require floor space. Hanging pots are available, but due to their size and shape, they are not appropriate for multiple plants.

Furthermore, the dirt in these horizontal planters is exposed, and thus vulnerable to infestation by soil living pests and to dehydration. Various improvements have been proposed to alleviate these problems.

Unlike traditional gardening which spreads plants out horizontally, vertical growing systems layer plant vertically. Growing plants vertically can increase the yields up to three times per square foot of growing area. Expensive greenhouse space can make this a major incentive to utilize vertical growing systems commercially as well.

A number of homemade and commercial growing systems have been developed in the past. Many of these use large (4 inches or larger) PVC pipe with holes drilled are formed in the sides. FIGS. 1 and 1A show examples of such vertical growing systems. Referring to FIGS. 1 and 1A, there is shown a vertical PVC pipe 10. A plurality of holes 12 are drilled or formed in the side of the PVC pipe 10. Plants are shown in FIG. 1A as extending outwardly from the holes 12 of the PVC pipe 10. These apparatuses are described in U.S. Pat. No. 5,715,629 and U.S. Patent Application Publication No. 2004/0010971. In each of these examples, a growing medium, such as soil, is placed in the PVC pipe 10. However, without an external shape around the various holes 12, water and growing media are prone to spillage.

U.S. Patent Publication No. 2014/0223816, published on Aug. 14, 2014 to Parker, also discloses a vertical gardening apparatus. The vertical apparatus of the Parker publication is similar to the previously-described apparatuses. However, the Parker apparatus further includes an internal conduit within the tubing so as to provide water to the interior of the tubing. The Parker device similarly includes holes formed in the wall of a pipe so as to allow for aeration and access for plants be planted in the growing medium within the pipe.

Another way of making a homemade vertical growing system is disclosed in FIG. 2. FIG. 2 shows a plurality of PVC pipe members 16 stacked upon each other. The PVC pipe members 16 have deformations 18 formed therein. The deformations essentially push the wall of the PVC pipe back so as to allow a plant to grow upwardly from the PVC pipe section below the deformation 18. Commonly, a heat gun or similar device is used to deform the plastic of the PVC pipe after a plurality of horizontal slits are made in the pipe. This deformation requires pulling the PVC out below the slit and pushing it in above the slit. This creates an opening where a plant can be inserted. Making these openings is difficult and time-consuming because the PVC pipe must be heated to a precise temperature, and the plastic be deformed a specific way or the container fails. Additionally, the finished product is not very attractive, often having a number of irregularities 20 as shown in FIG. 2.

FIG. 3 shows another common way of providing a homemade vertical growing system. Referring to FIG. 3, it is shown how there is a PVC pipe 30. Holes are drilled in the PVC pipe 30 and PVC elbows 32 attached to the holes. The PVC elbows 32 can be 45° or 90° angles relative to the larger PVC pipe 30. A weld or glue 34 is shown as forming the attachment between the PVC elbows 32 and the PVC pipe 30. Similar to the method described in FIG. 2, the vertical growing system shown in FIG. 3 is an equally expensive and time-consuming approach. Additionally, the approach of FIG. 3 is not necessarily waterproof, as the welds or gluing is not professionally done.

FIG. 4 shows a prior art commercial application of a vertical growing system. This growing system is described in U.S. Pat. No. 6,840,008, issued on Jan. 11, 2005 to Bullock et al. The commercial system 22 shown in FIG. 4 includes a plurality of growing containers 24. The growing containers 24 pre-formed and are suitable for mounting on a support pole 26. A watering system 28 is shown providing water to the plurality of growing containers 24. This is one example of the current state of the art for commercial systems wherein a custom container incorporates the shape necessary to prevent leaking water and spilling media. The system only offers pre-specified opening sizes and spacing for planting. Additionally, this type of a system can be too expensive for the typical gardener.

Various other patent have issued in the past relating to vertical growing systems. For example U.S. Pat. No. 6,094,861, issued on Aug. 1, 2002 to Sandman et al., describes a vertical growing apparatus commonly used for growing tomatoes. In the apparatus of the Sandman patent, a bucket is hung wherein the vines of the tomato plant extend downwardly and outwardly of the bottom of the container. A drip well in the top of the container provides a constant source of moisture.

U.S. Pat. No. 5,598,662, issued on Feb. 4, 1997 to Droste, describes a pole garden and fountain. The pole garden and fountain of the Droste patent has a vertical pole which has a plurality of containers affixed thereto. The containers are suitable for holding a plant pot and are arranged such that water flows downwardly from one container to the next.

It is an object of the present invention to provide a vertical growing system which is inexpensive and relatively easy to construct.

It is another object of the present invention to provide a vertical growing system which utilizes readily available, inexpensive containers.

It is another object of the present invention to provide a vertical growth going system which utilizes plant receptors having flanges for watertight statement to the container.

It is another object of the present invention to provide a vertical growing system with a relatively low cost of manufacturing and delivery.

It is another object of the present invention to provide watertight plant receptors which can be attached to a variety of containers, such as pipes, barrels or buckets.

It is yet another object of the present invention provide a vertical growing system having plant receptors which can vary in size and shape according to requirements of the plant.

It is yet another object of the present invention to provide a vertical growing system suitable for use in automatic planting and harvesting operations.

These and other objects and advantages of the present invention will become apparent from a reading of the attached specification and appended claims.

### BRIEF SUMMARY OF THE INVENTION

An embodiment of the present invention is an apparatus for use in vertical planting applications. The apparatus includes a plate with an opening formed therethrough. The plate has an area substantially greater than an area of the opening of the plate. A hollow pocket is positioned over the opening of the plate and extends outwardly from the plate. The hollow pocket has a plant portal that is positioned at a level above the level of the opening of the plate.

In an embodiment, the plate has a radius suitable for positioning against a container having a radius of the same value. Alternatively, the plate may have a flat rear side suitable for positioning against a flat surface. Preferably, the apparatus is constructed of a thermoformed PVC material.

In an embodiment, the plate has a height substantially greater than a height of the hollow pocket. Similarly, in an embodiment, the plate has a width substantially greater than a width of the hollow pocket. Preferably, the plate has a vertical longitudinal axis and a central axis of the plant portal extends at an acute angle relative to the vertical longitudinal axis of the plate.

In an embodiment of the present invention, the hollow pocket includes a cupped lower portion extending angularly outwardly from the plate. A flat upper portion extends from the cup portion to the plate. A plant portal is formed in the flat upper portion. A ridge extends around at least a lower perimeter of the plant portal.

The present invention may also be a system for vertical planting including a container with a plurality of holes formed through the wall thereof. A plurality of plant receptors are respectively affixed over the plurality of holes. Each of the plurality of plant receptors includes a plate with an opening formed therethrough. The opening is aligned with one of the plurality of holes of the container. The plate has a rear surface suitable for abutting the wall to container. The plate has an area substantially greater than the area of the opening of the plate. A hollow pocket is positioned over the opening of the plate. The hollow pocket extends outwardly from the plate. The hollow pocket has a plant portal thereon which is positioned at a level above the level of the opening of the plate.

In an embodiment of the system of the present invention, the plate has radius of curvature equal to a radius curvature of the wall of the container. Alternatively, both the container and the rear surface of the plate are flat so as to abut each other. Preferably, the container and plurality of plant receptors of the system of the present invention are formed of PVC material, and are fixed to the plant receptors using PVC cement. The container is preferably empty. However, the container can be filled with a planting or growing medium.

In an embodiment of the system of the present invention, the plate of each of the plurality of plant receptors has flanges extending outwardly from the hollow pocket so as to contact the wall of the container.

The present invention is also a method of vertical planting including steps of: (1) forming at least one hole in a wall of a container; (2) affixing a plant receptor to the container, the plant receptor having an opening in alignment with the at least one hole in the container, the plant receptor having flanges extending outwardly of a hollow pocket, the hollow pocket having a plant portal formed therethrough; and (3) planting a plant in a hollow pocket of the at least one plant receptor, wherein a root portion of the plant extends through the plant portal of the plant receptor, wherein an upper portion of the plan extends outwardly of the plant portal of the hollow pocket.

In the method of the present invention, at least one of the plant receptors may define a radius of curvature, wherein the radius of curvature of the flange is equal to a radius of curvature of an external surface of the wall the container. The method may include the step of filling the container with a planting medium. In the method, the container may preferably be selected from the group consisting of: a pipe, a barrel, a bucket and a square tube.

The foregoing “Summary of the Invention” is intended to describe the preferred embodiment of the present invention and, as such, should not be construed as limiting the scope of the present invention. The scope of the present invention should be defined by the claims herein. This Summary of the Invention should not be limiting of the various forms of the present invention that would be encompassed by the present claims.

### BRIEF DESCRIPTION OF THE SEVERAL VIEWS OF THE DRAWINGS

FIGS. 1 and 1A show prior art growing systems constructed by cutting holes in the sides of a pipe.

FIG. 2 shows the a vertical growing system constructed by cutting and then deforming PVC pipe of the prior art.

FIG. 3 shows a vertical growing system of the prior art constructed by gluing 90° pipe elbow fittings to holes cut in a pipe.

FIG. 4 shows the prior art example of a commercial vertical growing system wherein the container and plant receptors are manufactured together.

FIG. 5 shows a perspective view of the vertical growing system of the preferred embodiment of the present invention.

FIG. 6 shows a rear view of the plant receptor of the vertical growing system of the present invention.

FIG. 6 shows a front perspective view of an embodiment of the plant receptor of the present invention, wherein the flanges of the plant receptor are flat.

FIG. 8 shows a view of the vertical growing system of the present invention in a condition of use, where in multiple sizes of plant receptors are utilized for different types of plants.

FIG. 9 shows an isolated view of the hollow pocket of the plant receptor of the vertical growing system of the present invention.

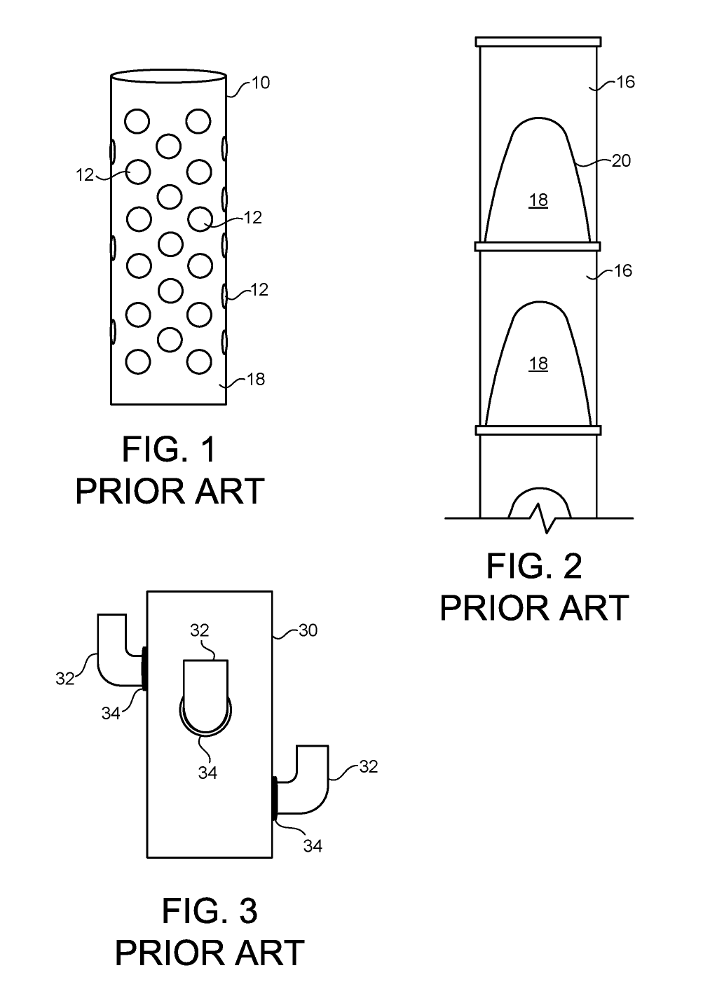

### DETAILED DESCRIPTION OF THE INVENTION

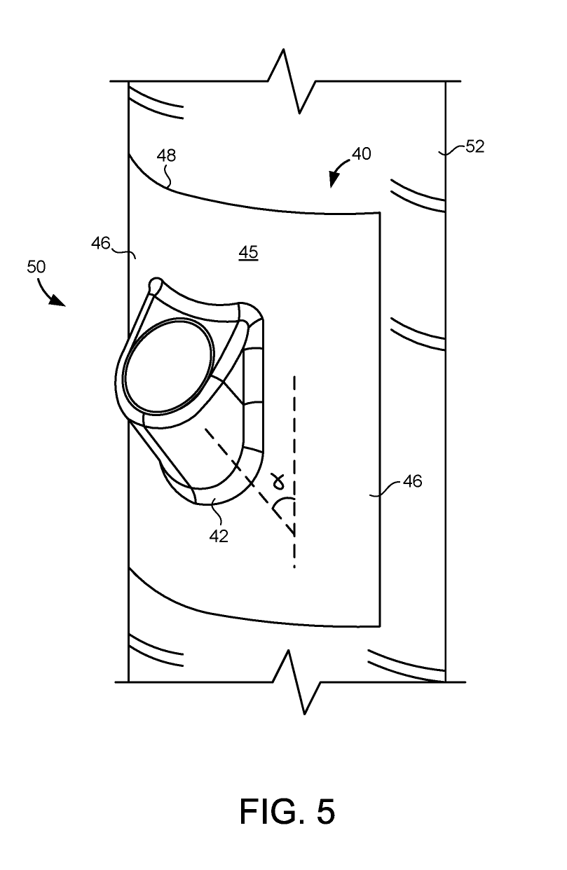

Referring to FIG. 5, there is shown the vertical growing system 50 of the preferred embodiment of the present invention. The vertical growing system 50, as shown in FIG. 5 includes a plant receptor apparatus 40 affixed to a container 52. The plant receptor apparatus 40 has a hollow pocket 42 with a plant portal 44 formed therethrough. The plant portal 44 is preferably in the form of a circular opening to accommodate commonly used seedling pots. The plant portal 44 accesses the interior of the hollow pocket 42. The hollow pocket 42 is affixed to or formed integrally with a plate 45 having flanges 46 extending outwardly therefrom. As can be seen in FIG. 5, a central axis of the plant portal 44 extends at an acute angle α relative to the longitudinal vertical axis of the container 52.

In FIG. 5, the container 52 is shown as a PVC pipe having a curved surface. The edge 48 of the plate 45 has a radius of curvature equal to the radius of curvature of the exterior wall of the container 52. This allows for the plant receptor apparatus 42 to abut the surface of the container 52 in a watertight manner.

A hole is drilled into the container 52, as will be described hereinbelow, which allows access from the plant portal 44 of the plant receptor apparatus 40 through the back of the plate 45 and into the hole drilled in the wall of the container 52. As such, the roots of a plant inserted in the plant portal 44 of the plant receptor apparatus 40 would have access to nutrients inside the container either from dispersed nutrient water in the preferred embodiment, or from growing media contained within the interior of the container 52. The installation of the plant receptor apparatus 40 is described hereinbelow.

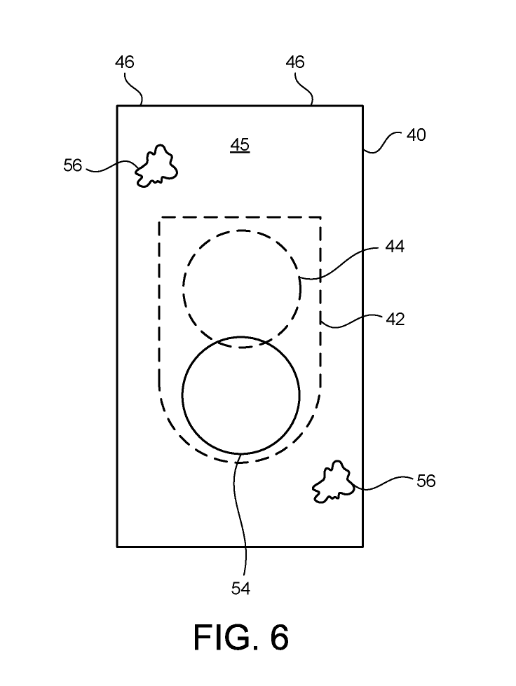

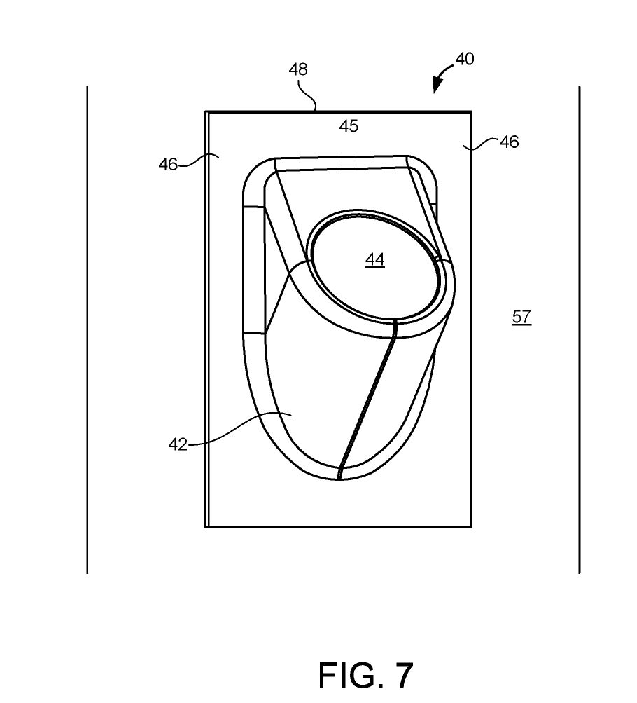

Referring to FIG. 6, there is shown a rear view of the plant receptor apparatus 40 of the vertical growing system 50 of the present invention. Importantly, FIG. 6 shows a rear opening 54 formed in the plate 45 of the plant receptor apparatus 40. The plant portal 44 as well as the hollow pocket 42 are shown in FIG. 6 in broken lines. This illustrates how the opening 54 of the plate 45 does not align with the plant portal 44 of the hollow pocket 42. This opening 54 is aligned with a hole drilled in the surface of the container 52. The opening 54 can be any number of shapes. However, utilizing the circular shape allows for better fitment with the surface of the container 52. Preferably, the plant portal 44 is positioned at a level above the opening 54 of the plate 45.

In the preferred embodiment of the present invention, the plant receptor apparatus 40 and container 52 are formed of PVC material. The plant receptor apparatus 40 is preferably formed of thermoformed PVC, which allows for a solvent weld using common PVC cement between the plant receptor apparatus 40 and the PVC pipe or container 52. An adhesive 56 is shown on the back surface of the plate 45 in FIG. 6. This adhesive 56 is applied prior to fitment of the plant receptor apparatus 40 to the container 52. Use of thermoforming for the plant receptor apparatus 40 provides for inexpensive, high-volume production. The plant receptor 40 and container 52 may be formed of other materials, but are ideally formed of the same material such that a heat or chemical weld can be formed for attachment purposes.

Preferably, the flanges 46 of the present invention are formed integrally with the remainder of the plant receptor apparatus 40. This allows for easy, watertight vertical gardening. As compared with the prior art, the flanges 46 of the present invention allow for a very watertight attachment to the container 52. The prior art does not include such individual plant receptors which are secured to containers via flanges.

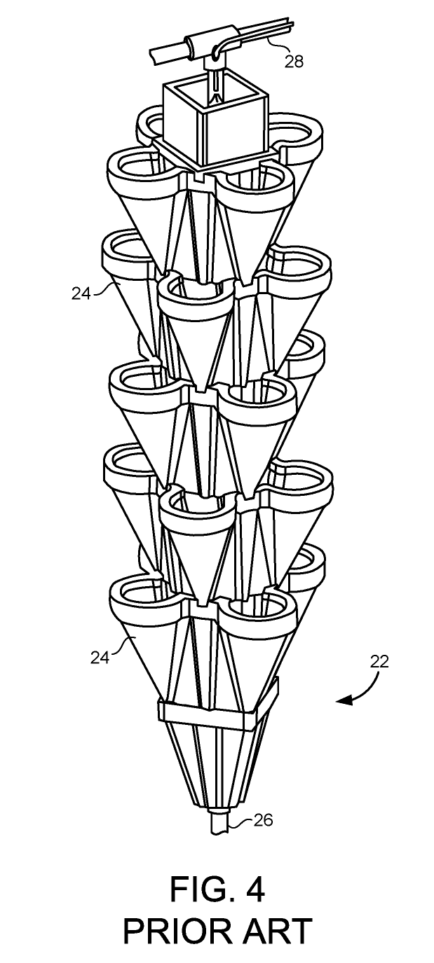

Because the width, height and area of the plate and flanges are substantially greater than the width, height and area of the opening on the back side of the plate, the present invention provides a greater surface-to-surface contact area as compared with the prior art. This assures a better seal than the point-to-point contact are as shown in the prior art, and particularly as shown in FIG. 3. The greater surface-to-surface contact area allows for more adhesive or glue to be used so as to create a watertight seal between the two surfaces. The greater surface-to-surface contact area minimizes possible damage to the apparatus which may be caused by cracking and water penetration.

As noted above, the container 52 can take any number of forms, including pipes, barrels or buckets. In some instances, the container may have a flat outer surface, such as when a square PVC tubing is utilized.

FIG. 7 shows an embodiment of the present invention wherein the container has a flat face 57. In this instance, the plant receptor apparatus 40 has flanges 46, which are flat so as to abut the flat surface of the container. PVC fence posting is a common square tubing for use in this application. By providing apparatuses to accommodate a variety of containers, the present invention lowers cost for gardeners, allowing them to use readily available containers, eliminating shipping of bulky items.

The plant receptor apparatus 40 of the present invention can be manufactured in a number of sizes. The preferred embodiments include those designed for a four inch PVC pipe wherein there is a two inch opening for the plants.

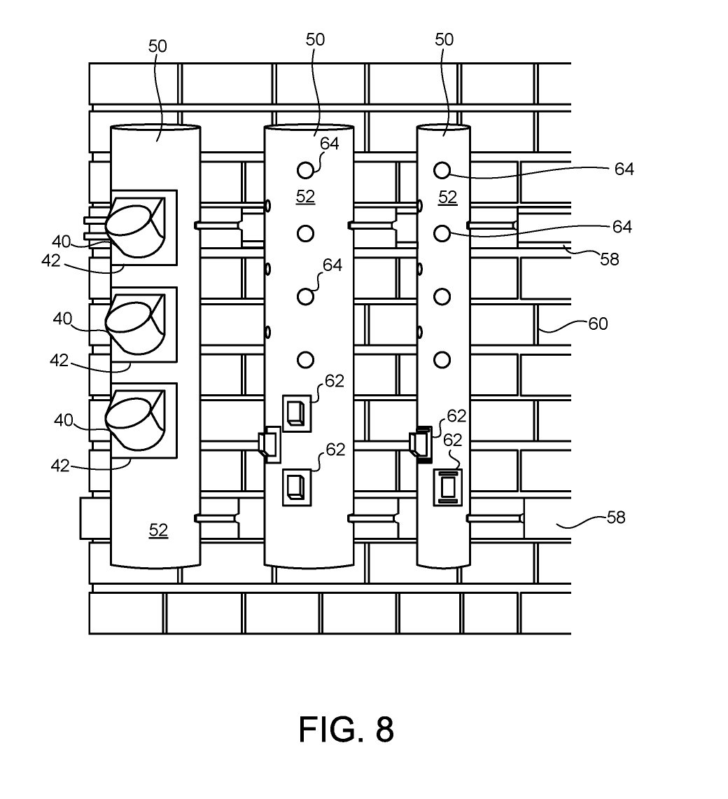

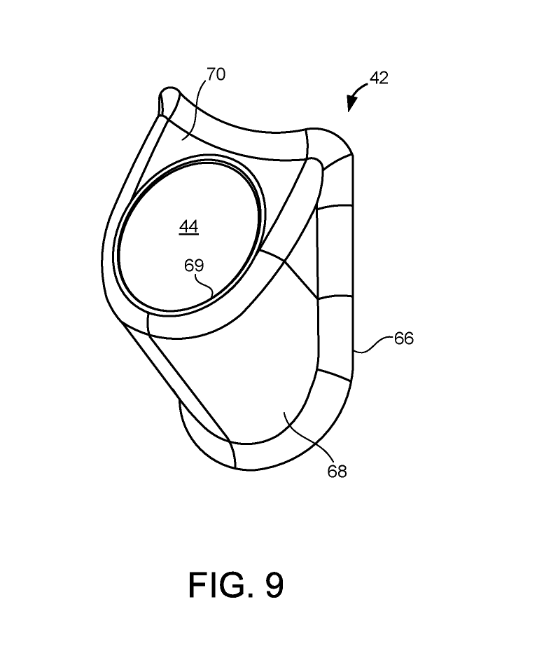

FIG. 8 illustrates the method of the present invention. First, a hole 64 is drilled or formed in the wall of the container 52. FIG. 8 shows a plurality of holes 64. These holes 64 are matched to the size of the opening of the plant in the particular plant receptor apparatus being used. Next, at least one of the plant receptors 42 is affixed to the container. Preferably, an appropriate glue or PVC cement is applied to the flanges of the plant receptor 40 of the system of the invention. Next, the plant receptor for 40 is placed in contact with the container and becomes permanent attached by means of the glue. Preferably, the rear opening of the plant receptor 40 is in alignment with the hole formed in the wall of the container. The flanges of the plant receptor 40 extend outwardly of the hollow pocket so as to conform with the exterior surface of the container 52. Plants are then placed in the hollow pocket of the plant receptor such that a portion of the plant extends outwardly of the plant portal of the hollow pocket. The roots of the plant extend through the hole in the vertical container, while the rest of the plant remains exposed to sunlight.

As noted above, in the preferred embodiment of the present invention, the container is left empty. The plants can be grown aeroponically using a variety of spray irrigation systems. For example, large orifice sprinkler heads can be used to feed the plant, providing nutrient water to the interior of the container. By leaving the container empty, this allows for easy swapping out of individual plants without having to untangle the roots from media in the container.

Alternatively, prior to placing the plant in the plant receptor, the container can be filled with a planting or growing medium, such as soil, expanded shale, expanded clay balls, perlite, dermiculite, coconut coir, or any other appropriate planting or growing media.

FIG. 8 shows how different sized plant receptors can be utilized. For example, the smaller plant receptor 62 shown on the two rightmost containers can be utilized for smaller plants, while the conventionally-sized larger plant receptors 40 having larger hollow pockets 42 are utilized in the leftmost embodiment. Each of the systems 50 is affixed to a wall 60 utilizing hanging members 58. Various sizes of plant receptors can also be utilized on the same container.

Referring to FIG. 9, there shown an isolated view of the hollow pocket 42 of the plant receptor apparatus 40 of the present invention. In FIG. 9, it can be seen how the hollow pocket 42 has an edge surface 66, where the hollow pocket 42 transitions to the plate portion of the plant receptor apparatus 40. This edge 66 serves to prevent sharp 90° edges or connection points. This enhances the structural integrity of the apparatus of the present invention, and prevents such connections from being compromised.

The hollow pocket 42 further includes a lower cupped portion 68. The lower cupped portion 68 extends angularly upwardly and outwardly from the plate member 45. An upper flat portion 70 is shown as extending from the lower cupped portion 68 towards the edge surface 66. The upper flat portion 70 contains the plant portal 44. The lower cupped portion 68 of the hollow pocket 42 allows for the planting medium and water to collect in the hollow pocket 42 without spilling over outwardly of the plant portal 44. Preferably, the hollow pocket 42 is formed integrally with the plate member 45.

FIG. 9 also shows how the plant portal 44 has a ridge 69 formed along at least a lower perimeter thereof. This ridge 69 is important in that it prevents soil or water from falling out of the plant portal 44.

The plant receptor apparatus of the present invention can be manufactured by thermoforming PVC material or through injection moldings procedures. As compared to the prior art, the present invention facilitates easy and inexpensive construction of a vertical growing system since only the plant receptor apparatus which is attached to the container is manufactured and shipped, rather than the entire container, which is the case in the prior art. This reduction in cost is so significant that it is a viable alternative various homemade vertical systems, as described hereinabove, which are very difficult and very labor-intensive to produce. The present invention can also be used with or without growing media for the roots the plants. Standard horticultural plant plugs can also be used.

Unlike the current state of the art, different sizes of the plant receptor apparatus and present invention can be used in the same container, and they can be placed at any spacing the grow requires.

The system of the present invention is versatile in that it allows for any growing media, irrigation, and nutrients as a delivery system that the user may select. This also enables vertical growing systems to be constructed using inexpensive materials such as pipes and is compatible with soil base, hydroponic, aeroponic or aquaponic gardening systems.

The system of the present invention provides several benefits in commercial vertical planting and harvesting operations. For example, the system of the present invention allows for uniform plant placement, so that the container can be placed on various conveyor systems. The conveyor systems deliver the container to a harvester and then returns the container to a growing position. This combination of easily transported containers and uniform plant placement means that robotic or automatic planting and harvesting are possible using the present invention. Additionally, the present invention allows for easy plant placement and exchange as compared to the prior art systems, which is a primary requirement for such automatic operations.

The foregoing disclosure and description of the invention is illustrative and explanatory thereof. Various changes in the details of the illustrated construction can be made is the scope of the present invention without departing from the true spirit of the invention. The present invention should only be limited by the following claims and their legal equivalents.

We claim:

1. An apparatus for use in vertical planting applications, the apparatus comprising:
a plate having an opening formed therethrough, said plate having an area substantially greater than an area of said opening of said plate; and
a hollow pocket positioned over said opening of said plate, said hollow pocket extending outwardly from said plate, said hollow pocket having a plant portal, said plant portal positioned at a level above a level of said opening of said plate.

2. The apparatus of claim 1, said plate having a radius suitable for positioning against a container having a radius of the same value.

3. The apparatus of claim 1, said plate having a flat rear side suitable for positioning against a flat surface.

4. The apparatus of claim 1, wherein the apparatus is constructed of thermoformed PVC material.

5. The apparatus of claim 1, said plate having a height substantially greater than a height of said hollow pocket.

6. The apparatus of claim 1, said plate having a width substantially greater than a width of said hollow pocket.

7. The apparatus of claim 1, said plate having a vertical longitudinal axis, a central axis of said plant portal extending at an acute angle relative to said vertical longitudinal axis of said plate.

8. The apparatus of claim 1, said hollow pocket comprising;
a cupped lower portion extending angularly outwardly from said plate;
a flat upper portion extending from said cupped lower portion to said plate, said plant portal formed in said flat upper portion; and
a ridge extending around at least a lower perimeter of said plant portal.

9. A system for vertical planting comprising:
a container having a plurality of holes formed through a wall thereof; and
a plurality of plant receptors respectively affixed over said plurality of holes, each of said plurality of plant receptors comprising:
a plate having a opening formed therethrough, said opening being aligned with one of said plurality of holes of said container, said plate having a rear surface suitable for abutting said wall of said container, said plate having an area substantially greater than an area of said opening of said plate; and
a hollow pocket positioned over said opening of said plate, said hollow pocket extending outwardly from said plate, said hollow pocket having a plant portal thereon, said plant portal positioned at a level above a level of said opening of said plate.

10. The system of claim 9, said plate having a radius of curvature equal to a radius of curvature of said wall of said container.

11. The system of claim 9, wherein both of said container and said rear surface of said plate are flat.

12. The system of claim 9, said hollow pocket comprising;
a cupped lower portion extending angularly outwardly from said plate; and
a flat upper portion extending from said cupped lower portion to said plate, said plant portal formed in said flat upper portion.

13. The system of claim 9, said plate having a vertical longitudinal axis, a central axis of said plant portal extending at an acute angle relative to said vertical longitudinal axis of said plate.

14. The system of claim 9, said plurality of plant receptors being formed of a material identical to the material forming the container such that heat or chemical welds can be formed.

15. The system of claim 14, said plurality of plant receptors being affixed to said container using PVC cement.

16. The system of claim 9, said container being filled with a planting medium.

17. The system of claim 9, said plate of each of said plurality of plant receptors having flanges extending outwardly from said hollow pocket so as to contact said wall of said container.

18. A method of vertical planting comprising the steps of:
forming at least one hole in a wall of a container;
affixing at least one plant receptor to said container, said plant receptor having an opening in alignment with said at least one hole of said container, said plant receptor having flanges extending outwardly of a hollow pocket, said hollow pocket having a plant portal formed therethrough; and
planting a plant in said hollow pocket of said at least one plant receptor, a root portion of said plant extending through said plant portal of said plant receptor, an upper portion of said plant extending outwardly of said plant portal of said hollow pocket.

19. The method of claim 18, a rear surface of said flanges of said at least one plant receptor defining a radius of curvature, said radius of curvature of said flanges being equal to a radius of curvature of an external surface of said wall of said container.

20. The method of claim 18, further comprising the step of:
filling said container with a planting medium.
